(19) United States
(12) Patent Application Publication
(10) Pub. No.: US 2019/0210208 A1
(43) Pub. Date: Jul. 11, 2019

(54) TOOL FOR MULTIPLE SEQUENTIAL OPERATIONS AND METHODS FOR USE

(71) Applicant: John Christopher Codiga, Santa Cruz, CA (US)

(72) Inventor: John Christopher Codiga, Santa Cruz, CA (US)

(21) Appl. No.: 16/241,643

(22) Filed: Jan. 7, 2019

Related U.S. Application Data
(60) Provisional application No. 62/614,355, filed on Jan. 6, 2018.

(51) Int. Cl. B25F 5/02; B23B 45/00; B25B 21/00

(52) U.S. Cl. CPC B25F 5/02; B25F 3/00; B25B 21/002; B23B 45/001

(57) ABSTRACT

A tool system dual rotating heads to allow for sequential operations without changing of the tool tip. The tool system is adapted to allow for complementary repetitive operations. The tool may have opposite facing rotating heads, and may be adapted to have only a selected head at any one time. The tool may include an electric drive motor which drives internal and external cleaning brushes adapted to remove oxidation and contamination from the surfaces of pipe segments before soldering, for example.

### CROSS-REFERENCE TO RELATED APPLICATIONS

This application claims priority to U.S. Provisional Patent Application No. 62/614,355 to Codiga, filed Jan. 6, 2018, which is hereby incorporated by reference in its entirety.

### FIELD OF THE INVENTION

This invention relates to power tools, namely a single tool with multiple rotating heads.

### BACKGROUND OF THE INVENTION

In some industrial applications, and in some home improvement work scenarios, a user may need to perform a pair of sequential operations one after the other, and then repeat this pair of operations again. For example, when attaching wooden members, the user may first drill a pilot hole and then drive a screw using the pilot hole. Presently a user may use a pair of electric devices to perform a pair of operations, and it is not uncommon for retailers to sell a package of devices, such as a drill and a driver, together.

An industrial application where a pair of operations may be performed sequentially, and then repeated, is the preparation of pipe for joining. Copper is a superior material for conveying water, and is the prime material for such purposes. Copper tube for the plumbing, heating, and air-conditioning industries is available in drawn and annealed tempers (referred to as “hard” and “soft”. They are available in a large range of diameters and wall thickness.

In the United States copper tube is manufactured to meet the requirements of specifications established by ASTM International. All tube supplied to these ASTM standards is a minimum of 99.9 percent pure copper. Two common types of joining for copper and soldering and brazing. To make a satisfactory joint it is important to clean the surfaces of the pipe which are to be joined. Both the inside surface of an exterior pipe and the interior surface of an exterior pipe may be cleaned using a pair of rotating brushes, one an interior brush and one an exterior brush.

What is called for is a tool that allows the user perform two separate although related operations. What is also called for is a single tool which allows provision of two rotating interfaces, each of which may perform different operations.

### BRIEF DESCRIPTION OF THE DRAWINGS

FIG. 1 illustrates a dual tool with two drill chucks according to some embodiments of the present invention.

FIG. 2 illustrates a dual tool with two impact chucks according to some embodiments of the present invention.

FIG. 3 illustrates a dual tool with a drill chuck and an impact chuck according to some embodiments of the present invention.

FIG. 4 is a cross-sectional view of a dual tool with two drill chucks according to some embodiments of the present invention.

FIG. 5 is a cross-sectional top view of a dual tool with two drill chucks according to some embodiments of the present invention.

FIG. 6 is a cross-sectional view of a dual tool with two impact chucks according to some embodiments of the present invention.

FIG. 7 is a cross-sectional top view of a dual tool with two drill chucks according to some embodiments of the present invention.

FIG. 8 is a cross-sectional view of a dual tool with a drill chuck and an impact chuck according to some embodiments of the present invention.

FIG. 9 is a cross-sectional top view of a dual tool with a drill chuck and an impact chuck according to some embodiments of the present invention.

FIG. 10 is a partial side view of a lock out mechanism according to some embodiments of the present invention.

FIG. 11 is a partial view of a lock out mechanism according to some embodiments of the present invention.

FIG. 12 is a photograph of two copper pipe pieces prior to fitting.

FIG. 13 is a photograph of two copper pipe pieces fitted together.

FIG. 14 illustrates a tool system according to some embodiments of the present invention.

FIG. 15 is illustrates a tool according to some embodiments of the present invention.

FIG. 16 is a front cross-sectional view of a tool according to some embodiments of the present invention.

FIG. 17 is a top cross-sectional view of a tool according to some embodiments of the present invention.

FIG. 18 is a cross-sectional view of an external pipe cleaning portion according to some embodiments of the present invention.

FIG. 19 is a cross-sectional view of an internal pipe cleaning portion according to some embodiments of the present invention.

### SUMMARY

A tool system dual rotating heads to allow for sequential operations without changing of the tool tip. The tool system is adapted to allow for complementary repetitive operations. The tool may have opposite facing rotating heads, and may be adapted to have only a selected head at any one time. The tool may include an electric drive motor which drives internal and external cleaning brushes adapted to remove oxidation and contamination from the surfaces of pipe segments before soldering, for example.

### DETAILED DESCRIPTION

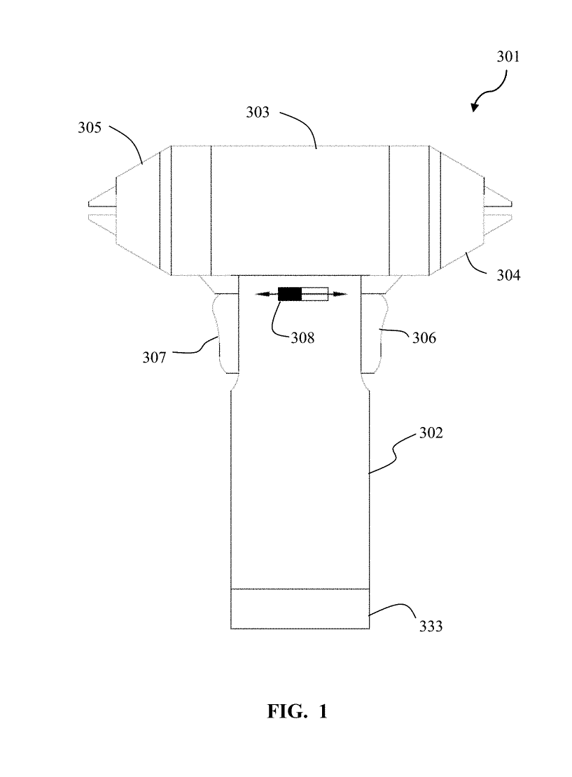

In some embodiments of the present invention, as seen in FIG. 1, a tool 301 adapted for multiple sequential operations has a tool handle 302 with a first rotating end piece 304 and a second rotating end piece 305. In this embodiment, the first rotating end piece 304 has a drill chuck and the second rotating end piece 305 also has a drill chuck. The rotating end pieces 304, 305 are coupled to a tool head 303. The tool handle 302 is coupled to a tool handle base 333 is configured along a longitudinal first axis. The spin axis of the first rotating end piece 304 and the spin axis of the second rotating end piece 305 are coaxial and configured with the tool head 303 along a lateral second axis which is perpendicular to the longitudinal first axis.

A direction switch 308 allows for selection of a spin direction of the first rotating end piece 304 and the second rotating end piece 305. A first trigger 306 is adapted to allow for the rotation of the first rotating end piece 304 when depressed, while the second rotating end piece remains locked in place. A second trigger 307 is adapted to allow for the rotation of the first rotating end piece 305 when depressed, while the second rotating end piece remains locked in place. Thus, when the tool is held by a user, the user may sight the targeted piece to be worked on while holding the tool body, and depress the trigger to rotate the rotating end piece on the same side as the depressed trigger. The user could then rotate the tool body along its long axis, and sight the targeted piece while holding the tool body, but in this configuration a different operation may be performed. For example, there may be a drill bit in the first rotating end piece, and a screw driving bit in the second rotating end piece. The user may alternate sequentially between drilling a pilot hole, and then driving a screw using the pilot hole.

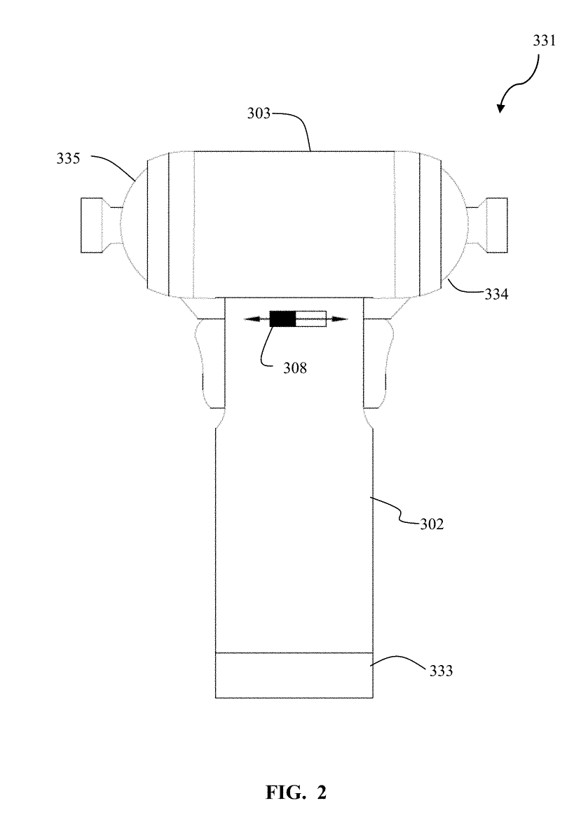

In some embodiments of the present invention, as seen in FIG. 2, a tool 331 adapted for multiple sequential operations has a tool handle 302 with a first rotating end piece 334 and a second rotating end piece 335. In this embodiment, the first rotating end piece 334 has an impact chuck and the second rotating end piece 335 also has an impact chuck.

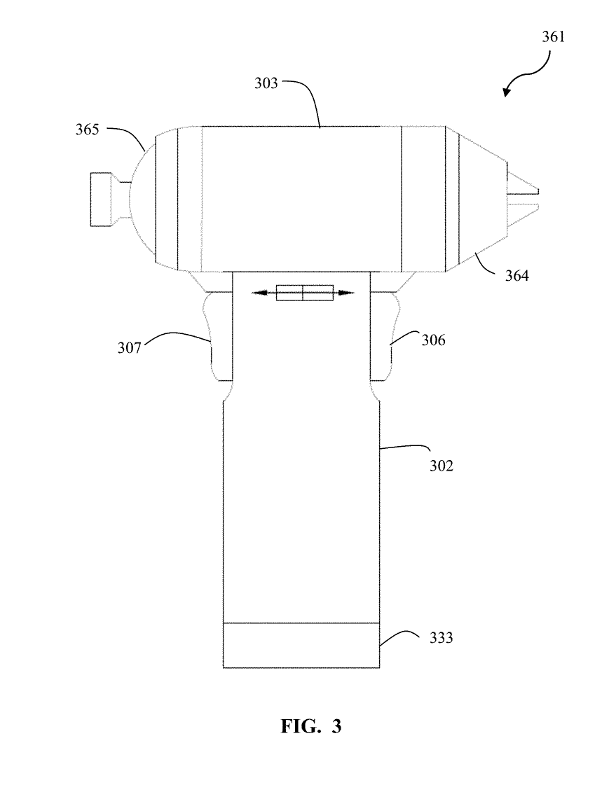

In some embodiments of the present invention, as seen in FIG. 3, a tool 361 adapted for multiple sequential operations has a tool handle 302 with a first rotating end piece 364 and a second rotating end piece 365. In this embodiment, the first rotating end piece 364 has a drill chuck and the second rotating end piece 305 has an impact chuck.

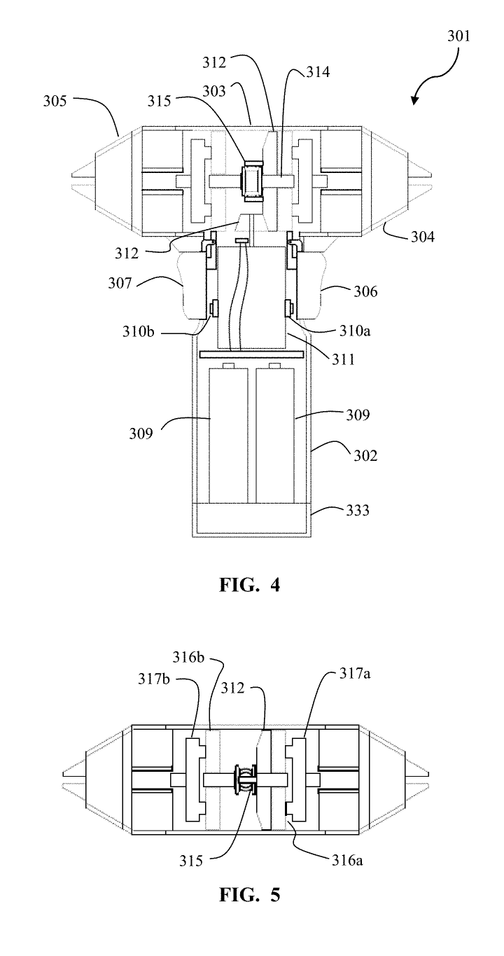

In some embodiments of the present invention, as seen in illustrative cross-section in FIGS. 4 and 5, the dual end tool 301 has batteries 309 within the tool handle 302. The batteries 309 are coupled to a drive motor 311. The first and second triggers 306, 307 perform a dual function. The triggers 306, 307 engage the second planetary gears 317a, 317b when not pressed, preventing their motion. The triggers 306, 307 press upon the motor switches 310a, 310b when pressed and activate the drive motor 311. As a switch is pressed on a particular side of the tool, it disengages a locking mechanism on that side of the tool so that the rotating end piece on that side is free to rotate while the rotating end piece of the other side is anchored and held stationary.

The drive motor 311 has a primary bevel gear 312 coupled to its output shaft. The output shaft has a primary bevel gear 312 which couples the motor, and the motor output shaft, to a drive system adapted to rotate a rotating end piece. The primary bevel gear 312 drives the secondary bevel gear 313 which is mechanically coupled to the primary drive shaft 314. A differential 315 allows for one of the primary planetary gears 316a, 316b to rotate and provide drive to a secondary planetary gear 317a, 317b when the other primary planetary gear is held in place, and locked, by a trigger lock out, as described below. In this scenario, the pressing of a trigger on one side both activates the motor and couples the rotating motor the rotating end piece on that side.

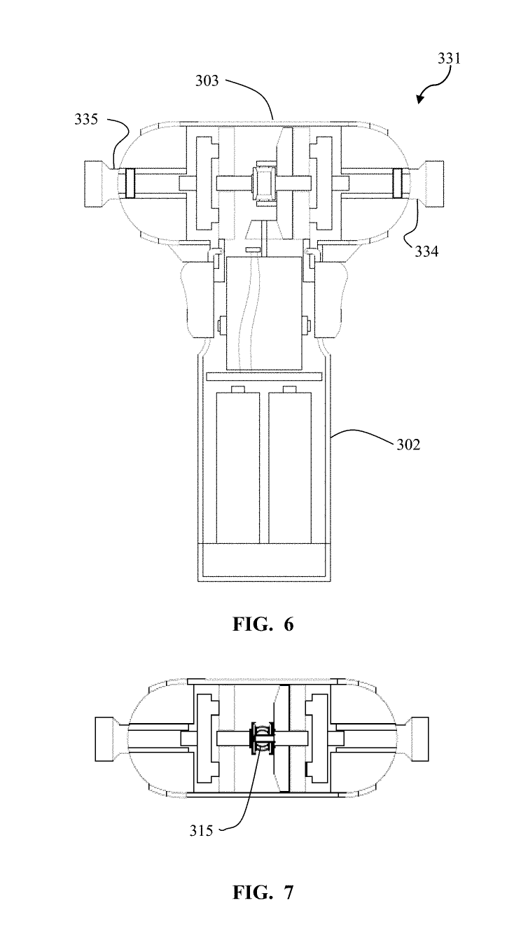

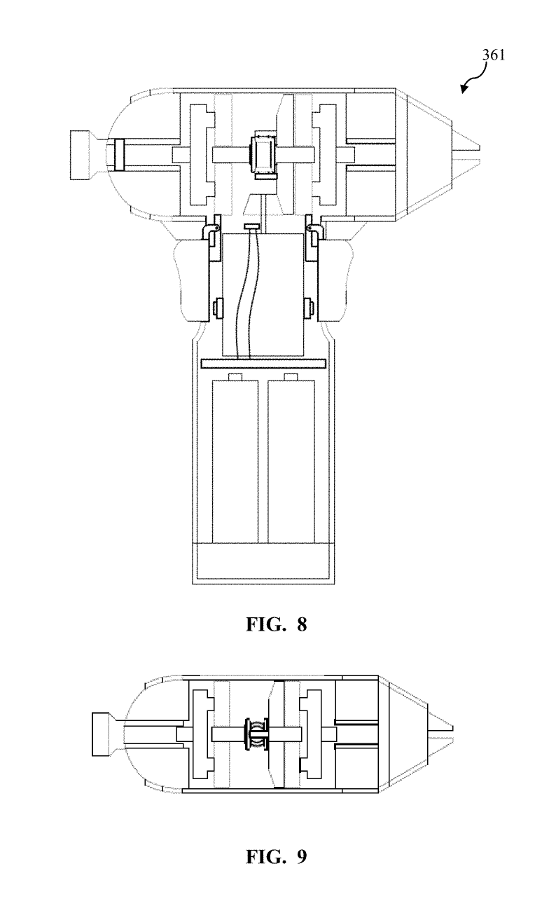

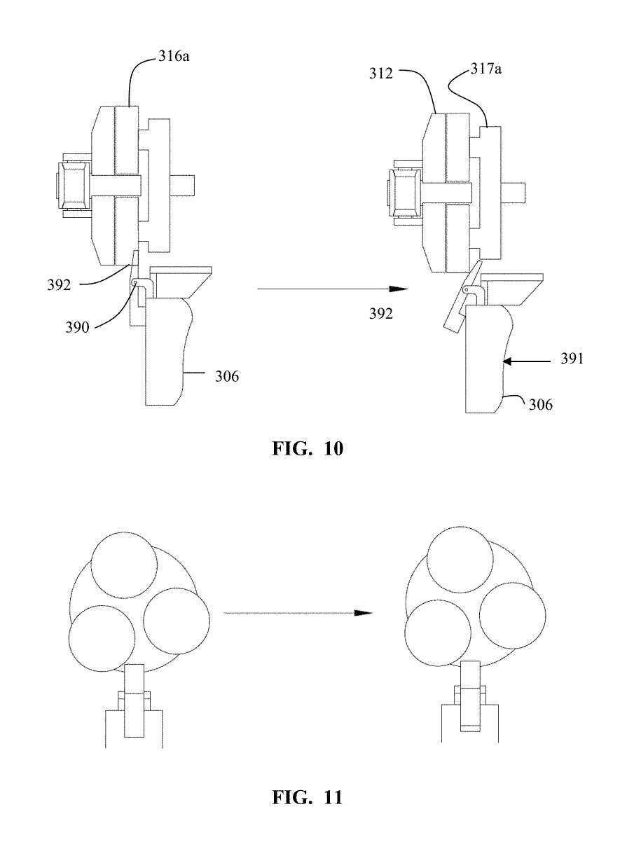

FIGS. 6 and 7 disclose in illustrative cross-section of the dual end tool 331 according to some embodiments of the present invention. FIGS. 8 and 9 disclose in illustrative cross-section of the dual end tool 361 according to some embodiments of the present invention.

FIGS. 10 and 11 illustrate aspects of the trigger and lock out devices adapted to allow a single rotating end piece to rotate while holding the other rotating piece in a stationary position. The trigger 306 is coupled to a lock out 392 via a pivot 390. With the trigger 306 not depressed, the lock out 392 engages the primary planetary gears 316a and prevents rotation. In some aspects, the lock out may engage a slot in the top of the outer gear body. In some aspects, the lock out may interfere with the rotation of the planetary system. When the trigger 306 is depressed 391, the lock out 392 pivots away from the primary planetary 316a while simultaneously depressing the motor switch 310a. The rotating end piece on the same tool side as the trigger will then rotate, being driven by the motor 311.

The soldering of copper pipe typically is done at temperatures in the range of 350 F to 600 F. The following steps are used in order to make a satisfactory joint: measuring and cutting, cleaning, applying flux, assembly and support, heating, applying solder, cooling and cleaning, and testing. With regard to the cleaning step, the removal of all oxides and surface soil from the tube ends and fitting caps is crucial to the proper flow of solder metal into the joint. Failure to remove them can interfere with capillary action and lessen the strength of the joint or cause failure.

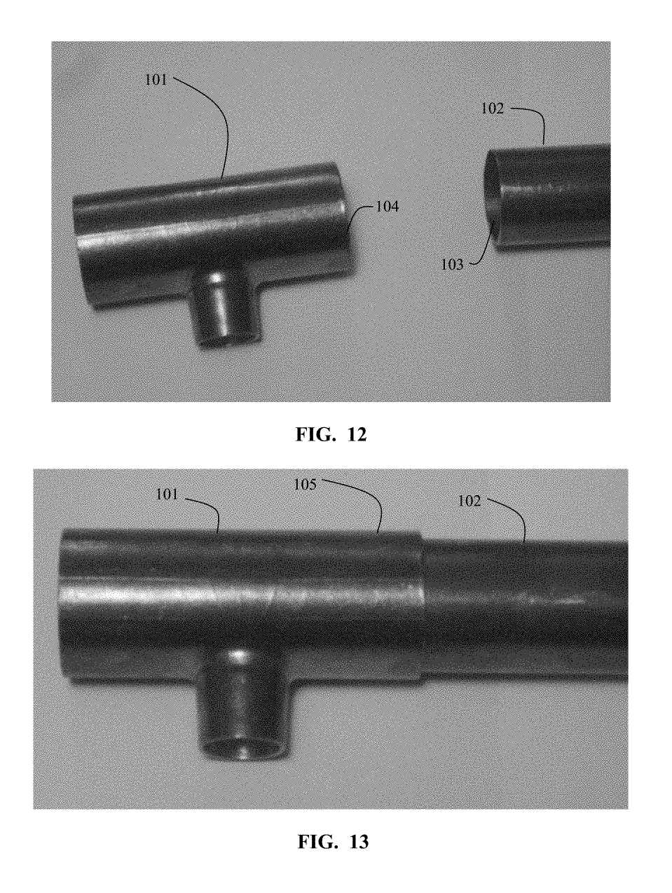

FIG. 12 is an illustration of a pipe 102 and a fitting 101 which are intended to be joined. As part of the cleaning step prior to soldering, it is desirable to clean the interior surface 104 of the fitting 101 and the exterior surface 103 of the pipe 102. FIG. 13 illustrates the pipe 102 and the fitting 101 placed together with an overlapping area 105. In the overlapping area 105 the interior surface 104 of the fitting 101 overlaps the exterior surface 103 of the pipe 102.

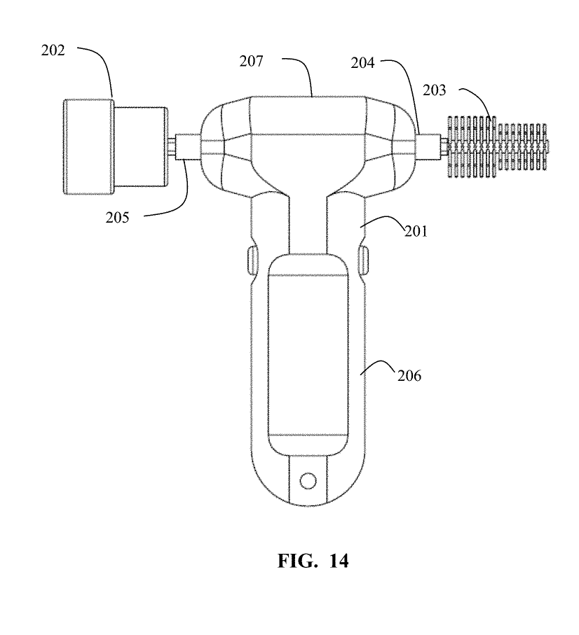

FIG. 14 is an illustration of a pipe preparation power tool 201 according to some embodiments of the present invention. The pipe preparation power tool 201 is adapted to allow for the use of a single tool to prepare both the interior surface of a fitting and the exterior surface of a pipe prior to joining. Also, the pipe preparation power tool allows for preparation of different diameter pipes with the same single tool. The power tool 201 has a power tool handle 206 and a power tool head 207. A male brush unit 203 is coupled to the power tool head 207 with a first coupling 204. A female brush unit 202 is coupled to the power tool head 207 with a second coupling 205. In some aspects, the male brush unit 203 may be decoupled from the power tool head 207 for cleaning or replacement. In some aspects, the female brush unit 202 may be decoupled from the power tool head 207 for cleaning or replacement.

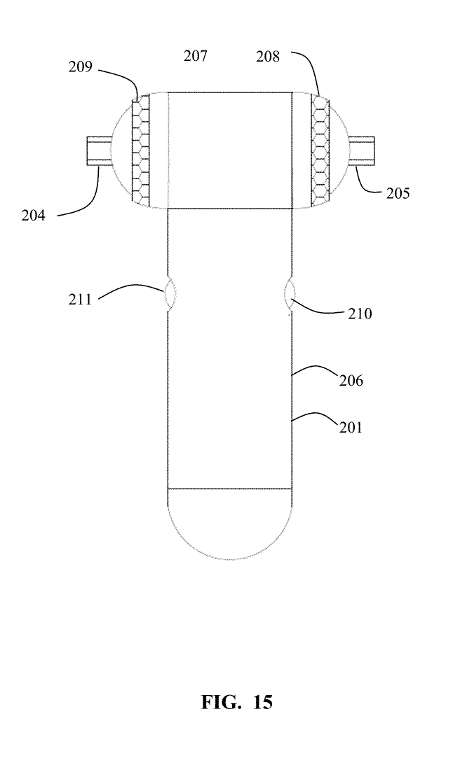

FIG. 15 is an illustration of a power tool 201 according to some embodiments of the present invention. The power tool handle 206 may have power buttons 210, 211 which are adapted to turn power on to rotate the first coupling 204 and the second coupling 205. In a circumstance where the powered aspect of the power tool 201 may not function, such as with a dead battery, locking mechanisms 208, 209 may be locked to direct drive the first coupling 204 and the second coupling 205 in unison with rotation of the power tool 201 around the central axis of the power tool head 207.

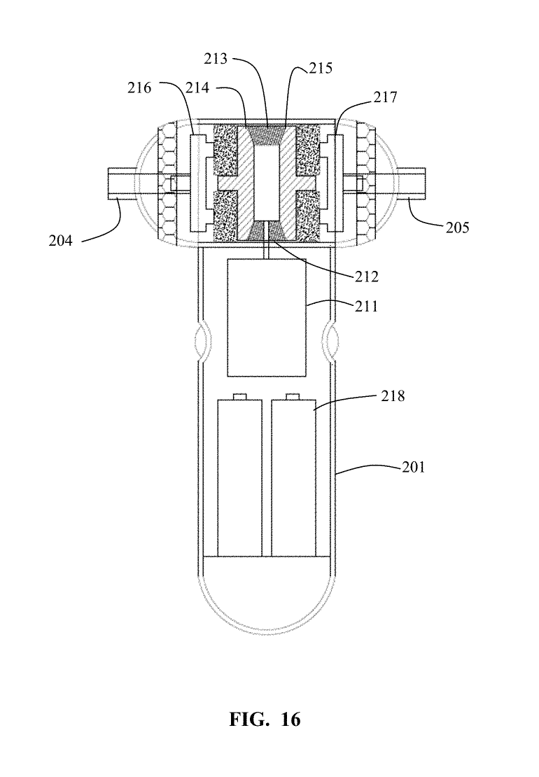

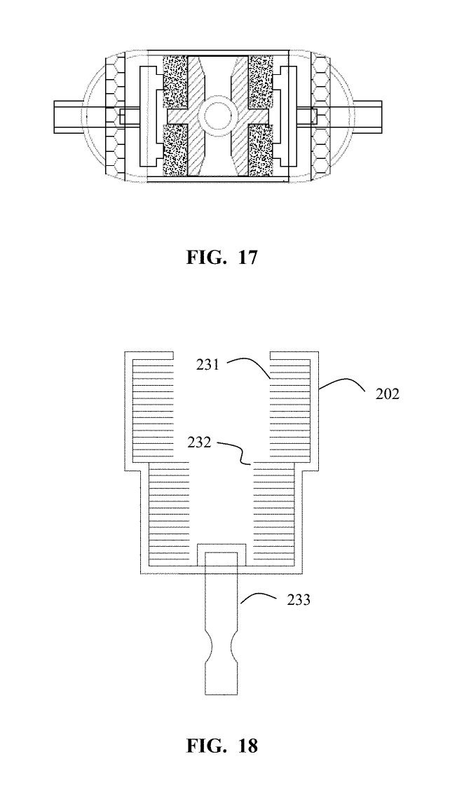

FIGS. 16 and 17 are partial cross-sectional views of a pipe preparation power tool 201 according to some embodiments of the present invention. Inside the power tool handle 206 of the power tool 201 reside one or more batteries 218 coupled to an electric motor 211. The motor may be activated by the use of power buttons 210. The electric motor 211 may drive a motor driven bevel gear 212. The motor driven bevel gear 212 may have a free spinning counterpart 213 which together allow the motor driven bevel gear to drive a first driven bevel gear 214 and a second driven bevel gear 215. The first driven bevel gear 214 in turn drives a first planetary gear set 216. The second driven bevel gear 215 drives a second planetary gear set 217. The output of the first planetary gear set 216 drives the first coupling 204 and the output of the second planetary gear set 217 drives the second coupling 205. In some embodiments, the output couplings which rotate the cleaning brushes may rotate in the range of 60-600 rpm. In some embodiments, the output couplings which rotate the cleaning brushes may rotate in the range of 60-1200 rpm. In some embodiments, the output couplings which rotate the cleaning brushes may rotate in the range of 60-6000 rpm.

FIG. 18 is a cross-sectional illustration of the female brush unit 202. The female brush unit 202 may have a first brush portion 231 of a larger interior diameter and a second brush portion 232 of a smaller interior diameter. In an exemplary embodiment, the first brush portion 231 has an interior diameter of 0.75 inches and the second brush portion 232 has an interior diameter of 0.5 inches. The female brush unit 202 may have a shank 233 adapted to attach to the first coupling 204.

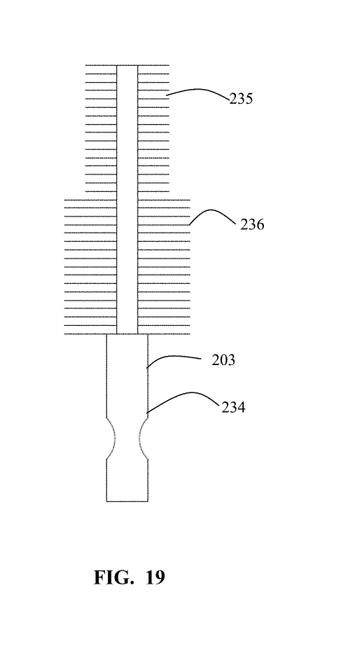

FIG. 19 is a cross-sectional illustration of the male brush unit 203. The male brush unit 203 may have a first brush portion 235 of a smaller diameter and a second brush portion 236 of a larger diameter. In an exemplary embodiment the first brush portion 235 has a diameter of 0.5 inches and the second brush portion 236 has a diameter of 0.75 inches. The male brush unit 203 may have a shank 234 adapted to attach to the second coupling 205.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A dual headed tool system, said dual headed tool system comprising:
a tool body, said tool having a first axis along a first direction, said tool body comprising:
a battery; and
a motor, said motor adapted to rotate a first rotating end piece and a second rotating end piece;
a tool head, said tool head comprising:
a first rotating end piece, said first rotating end piece protruding from said tool head along a first side of said tool body, said first rotating end piece adapted to rotate around a second axis perpendicular to said first axis in a second direction; and
a second rotating end piece, said second rotating end piece protruding from said tool head along a second side of said tool body opposite of said first side of said tool body, said second rotating end piece adapted to rotate around said second axis.

2. The dual headed tool system of claim 1 further comprising a drive system, said drive system coupled to said first rotating end piece, said drive system coupled to said second rotating end piece, wherein said motor comprises an output shaft, said output shaft coupled to said drive system.

3. The dual headed tool system of claim 2 further comprising a first trigger, said first trigger along said first side of said tool body, said first trigger adapted to cause rotation of said first rotating end piece when said first trigger is depressed.

4. The dual headed tool system of claim 2 further comprising a second trigger, said second trigger along said second side of said tool body, said second trigger adapted to cause rotation of said second rotating end piece when said second trigger is depressed.

5. The dual headed tool system of claim 3 further comprising a second trigger, said second trigger along said first side of said tool body, said second trigger adapted to cause rotation of said second rotating body when said second trigger is depressed.

6. The dual headed tool system of claim 5 wherein said first trigger comprises a trigger lock out adapted to lock the drive system coupled to said first rotating end piece when in a first position and to release the drive system coupled to said first rotating end piece when in a second, depressed, position, thereby allowing rotation of said first end piece.

7. The dual headed tool system of claim 6 wherein said second trigger comprises a trigger lock out adapted to lock the drive system coupled to said second rotating end piece when in a first position and to release the drive system coupled to said second rotating end piece when in a second, depressed, position, thereby allowing rotation of said second end piece.

8. The dual headed tool system of claim 2 wherein said first rotating end piece comprises a drill chuck.

9. The dual headed tool system of claim 5 wherein said first rotating end piece comprises a drill chuck.

10. The dual headed tool system of claim 8 wherein said second rotating end piece comprises a drill chuck.

11. The dual headed tool system of claim 9 wherein said second rotating end piece comprises a drill chuck.

12. The dual headed tool system of claim 8 wherein said second rotating end piece comprises an impact chuck.

13. The dual headed tool system of claim 9 wherein said second end piece comprises an impact chuck.

14. A pipe preparation system, said pipe preparation system comprising:
a tool body, said tool having a first axis along a first direction, said tool body comprising:
a battery; and
a motor, said motor adapted to rotate a first output coupling and a second output coupling;
a tool head, said tool head comprising:
a first output coupling, said first output coupling protruding from said tool head, said first output coupling adapted to rotate around a second axis perpendicular to said first axis in a second direction; and
a second output coupling, said second output coupling protruding from said tool head opposite of said first output coupling, said second output coupling adapted to rotate around said second axis.

15. The pipe preparation system of claim 14 further comprising an external brush unit coupled to said first output coupling.

16. The pipe preparation system of claim 15 further comprising an internal brush unit coupled to said second output coupling.

17. The pipe preparation system of claim 16 wherein said external brush unit comprises internal brushes with a plurality of internal diameters.

18. The pipe preparation system of claim 17 wherein said internal brush unit comprises external brushes with a plurality of external diameters.
